(19) United States
(12) Patent Application Publication
(10) Pub. No.: US 2025/0254261 A1
(43) Pub. Date: Aug. 7, 2025

(54) IMAGE FORMING APPARATUS AND MAINTENANCE METHOD OF COLORIMETER

(71) Applicant: Konica Minolta, Inc., Tokyo (JP)

(72) Inventor: Kazuomi Sakatani, Tokyo (JP)

(73) Assignee: Konica Minolta, Inc., Tokyo (JP)

(21) Appl. No.: 19/043,928

(22) Filed: Feb. 3, 2025

(30) Foreign Application Priority Data
Feb. 7, 2024 (JP) 2024-016937

(51) Int. Cl. H04N 1/60; G01J 3/46; H04N 1/00

(52) U.S. Cl. CPC H04N 1/6044; G01J 3/462; H04N 1/00567; H04N 1/6036

(57) ABSTRACT

An image forming apparatus includes an image former that prints a color chart on a sheet, an in-line colorimeter that performs color measurement of color patches formed on the color chart, and an image processor that performs color adjustment based on colorimetric values of the color patches formed on the color chart. The image processor combines multiple divided colorimetric data obtained by performing color measurement of color patterns into which a chart is divided, the chart in which color patches are arrayed to be common to the color chart, and obtains colorimetric values of the color patches formed on the color chart from the multiple divided colorimetric data combined.

### CROSS-REFERENCE TO RELATED APPLICATIONS

The entire disclosure of Japanese Patent Application No. 2024-016937 filed on Feb. 7, 2024, is incorporated herein by reference in its entirety.

### BACKGROUND OF THE INVENTION

### Technical Field

The present invention relates to an image forming apparatus and a maintenance method of a colorimeter.

### Description of Related Art

Conventionally, as an image forming apparatus, there is known an image forming apparatus in which a color chart printed by an image forming section is passed through an in-line color measurement section to be subjected to color measurement (colorimetry), and color adjustment is performed based on colorimetric values of a large number of color patches included in the color chart.

Various apparatuses have been proposed for a color measurement section that measures colors of a large number of color patches. For example, in a color measurement apparatus described in Japanese Unexamined Patent Publication No. 2000-283852, when color measurement is performed, a color measurement head can move without stopping, and thus color measurement of a large number of color patches can be efficiently performed.

In an image forming apparatus including an in-line color measurement section, color measurement of a color chart may not be performed due to failure of the in-line color measurement section or maintenance thereof, such as calibration. In such a case, color measurement may be performed using an external colorimeter in order to enable printing.

However, the size of a color chart the colors of which can be measured by an external colorimeter is often smaller than the size of a color chart the colors of which can be measured by an in-line color measurement section. When such an external colorimeter is used to measure colors of a large number of color patches one by one over many times to perform color adjustment, time and effort required for the color measurement and the color adjustment may be significantly increased.

Therefore, objects of the present invention include providing an image forming apparatus including an in-line color measurement section on which maintenance can be easily carried out and a maintenance method of a color measurement section.

### SUMMARY OF THE INVENTION

To achieve at least one of the abovementioned objects, according to an aspect of the present invention, an image forming apparatus reflecting one aspect of the present invention includes:
an image former that prints a color chart on a sheet;
an in-line colorimeter that performs color measurement of color patches formed on the color chart; and
an image processor that performs color adjustment based on colorimetric values of the color patches formed on the color chart,
wherein the image processor combines multiple divided colorimetric data obtained by performing color measurement of color patterns into which a chart is divided, the chart in which color patches are arrayed to be common to the color chart, and obtains colorimetric values of the color patches formed on the color chart from the multiple divided colorimetric data combined.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic configuration diagram of an image forming apparatus according to an embodiment(s) of the present invention;

FIG. 2 is a schematic block diagram of the image forming apparatus according to the embodiment of the present invention;

FIG. 3A is a diagram illustrating a chart printed sheet according to the embodiment of the present invention;

FIG. 3B is a diagram illustrating pattern printed sheets produced by cutting the chart printed sheet;

FIG. 4A is a diagram illustrating a color measurement method in an in-line color measurement section according to the embodiment of the present invention;

FIG. 4B is a diagram illustrating a color measurement method of pattern printed sheets in an external color measurement section;

FIG. 5A is a diagram illustrating an example of one pattern printed sheet in the embodiment of the present invention;

FIG. 5B is a diagram illustrating an example of divided colorimetric data of the pattern printed sheet;

FIG. 6A is a diagram illustrating an example of the other pattern printed sheet in the embodiment of the present invention;

FIG. 6B is a diagram illustrating an example of divided colorimetric data of the pattern printed sheet;

FIG. 7 is a flowchart illustrating a procedure for obtaining colorimetric values of all color patches from colorimetric data of the in-line color measurement section in an image processor according to the embodiment of the present invention;

FIG. 8A is a diagram illustrating an example of the color chart in the embodiment of the present invention;

FIG. 8B is a diagram illustrating an example of colorimetric data of the color chart;

FIG. 8C is a diagram illustrating an example of colorimetric data after discarding colorimetric values of a cutting region;

FIG. 9 is a flowchart illustrating a procedure for obtaining colorimetric values of all color patches from divided colorimetric data of the external color measurement section in the image processor according to the embodiment of the present invention;

FIG. 10A is a diagram illustrating an example of one color pattern according to the embodiment of the present invention;

FIG. 10B is a diagram illustrating an example of the other color pattern;

FIG. 10C is a diagram illustrating an example of divided colorimetric data of the color pattern illustrated in FIG. 10A;

FIG. 10D is a diagram illustrating an example of divided colorimetric data of the color pattern illustrated in FIG. 10B;

FIG. 11A is a diagram illustrating an example in which two divided colorimetric data according to the embodiment of the present invention are combined and rearranged;

FIG. 11B is a diagram illustrating another example in which two divided colorimetric data are combined and rearranged;

FIG. 12A is a diagram illustrating a chart printed sheet according to a modification example of the present embodiment;

FIG. 12B is a diagram illustrating one pattern printed sheet produced by cutting the chart printed sheet;

FIG. 12C is a diagram illustrating the other pattern printed sheet produced by cutting the chart printed sheet;

FIG. 13A is a diagram illustrating a chart printed sheet according to another modification example of the present embodiment;

FIG. 13B is a diagram illustrating a chart printed sheet according to another modification example of the present embodiment; and

FIG. 14 is a diagram illustrating a chart printed sheet according to another modification example of the present embodiment.

### DETAILED DESCRIPTION

Hereinafter, one or more embodiments of the present invention will be described with reference to the drawings. However, the scope of the invention is not limited to the disclosed embodiments.

Hereinafter, an example of an image forming apparatus according to an embodiment(s) of the present invention (which is hereinafter referred to as “the present embodiment”) will be described with reference to the drawings. In the following embodiment(s), a single-pass inkjet printer will be used as an example and described. Note that the present embodiment is not limited to the following examples. In the drawings described below, the same members are denoted by the same reference sign.

### First Embodiment

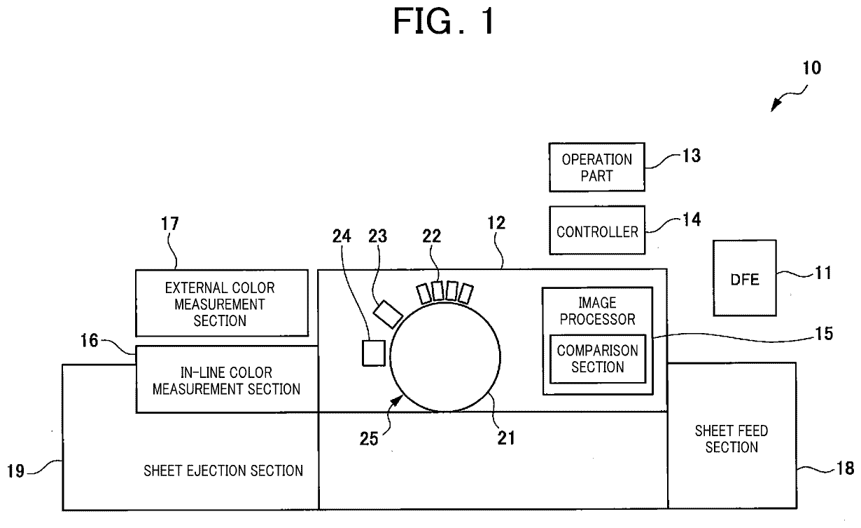

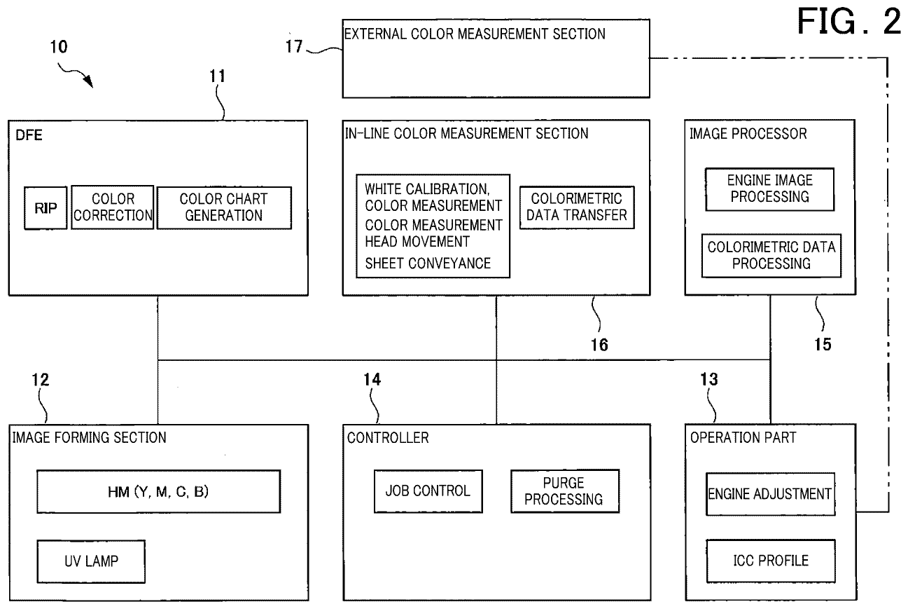

FIG. 1 is a schematic configuration diagram of an image forming apparatus according to the present embodiment, and FIG. 2 is a block diagram thereof. The image forming apparatus 10 includes a digital front end (DFE) 11, an image forming section 12 (image former), an operation part 13, a controller 14 (hardware processor), an image processor 15, an in-line color measurement section 16 (in-line colorimeter), and an external color measurement section 17 (external colorimeter).

The DFE 11 is a print controller and generates image data of a print image based on a print job received from an external apparatus, such as a client PC. The DFE 11 performs raster image processor (RIP) processing on image data included in the print job, and performs color correction to generate image data in a bitmap format.

The DFE 11 generates image data of a color chart 31 for color measurement. These mage data may be data created and saved in advance. The generated image data may be appropriately subjected to image processing, such as correction corresponding to unevenness of a print head, by the image processor 15, which will be described later.

Under the control of the controller 14, the image forming section 12 prints an image on a sheet from the sheet feed section 18 on the basis of the image data generated in the DFE 11, using various settings of the operation part 13, and ejects the sheet to the sheet ejection section 19.

The image forming section 12 includes a print engine 25 and an in-line sensor 24. The print engine 25 includes a main cylinder 21, head units 22 (CMYK), and a UV irradiator 23.

The print engine 25 forms an image with UV ink from the head units 22 on the sheet conveyed by the main cylinder 21, and cures the image with the UV irradiator 23. In order to inspect presence or absence of a defect in the image, the in-line sensor 24 reads the printed image and ejects the image to the sheet ejection section 19.

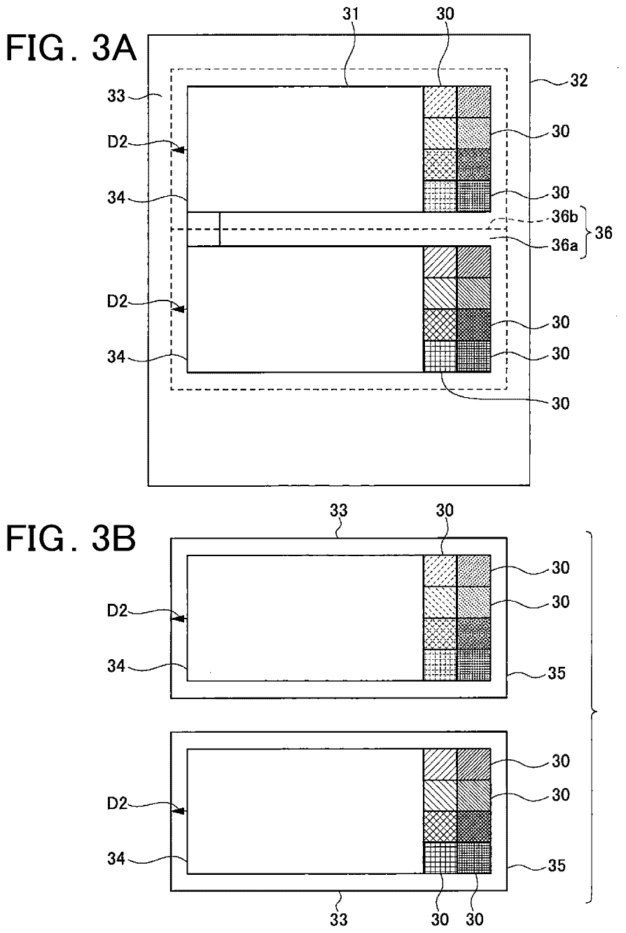

In the image forming section 12, image data of the color chart 31 (see FIG. 3A) for color measurement generated in the DFE 11 is printed on a sheet to produce a chart printed sheet 32.

The chart printed sheet 32 is conveyed directly and continuously from the image forming section 12 to the in-line color measurement section 16 on the basis of a signal for purge processing from the controller 14.

Hereinafter, the chart printed sheet 32 will be described. FIG. 3A illustrates the chart printed sheet 32 on which a color chart is printed. The color chart 31 according to the present embodiment is a chart in which color patches 30 are arranged (arrayed) vertically and horizontally. A margin 33 is provided around the color chart 31.

In the color chart 31, a large number of rectangular (or square) color patches 30 are arranged in a matrix. In the present embodiment, the color chart 31 have the color patches 30 for all colors included in the image data.

In the color chart 31, the large number of color patches 30 are divided to be arranged in a plurality of color patterns 34. The color patterns 34 are arranged so as to be separable from each other. This large number of color patches 30 are all the same in shape.

The chart printed sheet 32 is cut between the color patterns 34 to form pattern printed sheets 35 on which the color patterns 34 are printed. As shown in FIG. 3B, in the case of the chart printed sheet 32 of the present embodiment, two pattern printed sheets 35 are formed.

The pattern printed sheets 35 on which the color patterns are printed are formed by cutting the chart printed sheet 32. Therefore, the color patches 30 in the color patterns 34 of the pattern printed sheets 35 are the same in shape, and the color patches 30 in each color pattern 34 are also the same in shape. That is, the pattern printed sheets 35 have the color patterns 34 obtained by dividing a chart having an array common to (the same array/arrangement as) the color chart 31. In the present embodiment, the cutting is performed such that the color patterns 34 are the same in the number of color patches 30 arranged vertically and the number of color patches 30 arranged horizontally.

As shown in FIG. 3A, on the chart printed sheet 32, a cutting mark 36 is provided to indicate a position for cutting between the color patterns 34.

As the cutting mark 36 of the present embodiment, a cutting region 36a is provided between the two color patterns 34. The cutting region 36a is provided between the color patterns 34, having a width of an integral multiple of the color patch(es) 30. Usually, it is preferable that the cutting region 36a is colorless.

In addition, the cutting mark 36 of the present embodiment includes a cutting line 36b drawn between the color patterns 34. The cutting line 36b is continuously drawn so as to surround the outer periphery of each color pattern 34. Two pattern printed sheets 35 illustrated in FIG. 3B are produced by cutting the chart printed sheet 32 along the cutting line 36b.

Referring back to FIG. 1, the operation part 13 of the image forming apparatus 10 inputs various settings, information, and the like. For example, the operation part 13 inputs various settings for adjusting the print engine 25. Further, the operation part 13 inputs information, instructions, and the like for creating an ICC profile. Still further, the operation part 13 inputs divided colorimetric data 41a of the large number of color patches 30 the colors of which have been measured by the external color measurement section 17.

The controller 14 controls each component of the image forming section 12. The controller 14 performs job control to execute a print job. Further, the controller 14 performs purge processing for color measurement in the in-line color measurement section 16. The purge processing is processing of purging the chart printed sheet 32 ejected from the image forming section 12 so as not to be conveyed to the in-line color measurement section 16.

The in-line color measurement section 16 measures the colors of all the color patches 30 of the color chart 31, and transmits colorimetric data 41 to the image processor 15.

The in-line color measurement section 16 is constituted of an automatic sheet-passing type colorimeter. The chart printed sheet 32 is passed through the in-line color measurement section 16 directly and continuously from the image forming section 12. Therefore, the in-line color measurement section 16 has a sheet conveyance width same as the maximum width of sheets that can pass through the image forming section 12.

Since the image forming apparatus 10 according to the present embodiment is an apparatus capable of printing on large-sized sheets exceeding 320 mm, the in-line color measurement section 16 also has a sheet conveyance length of more than 320 mm.

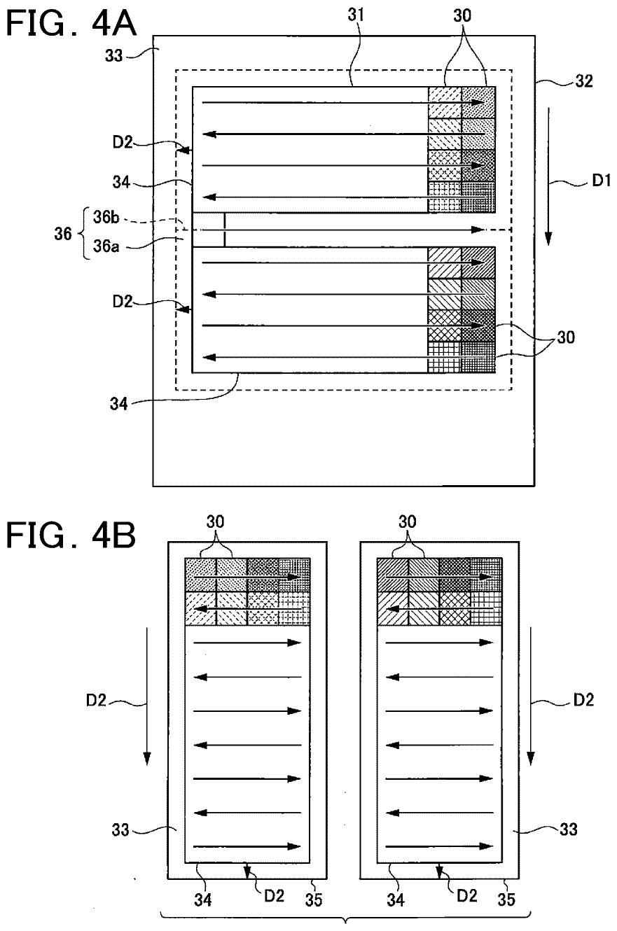

FIG. 4A is a diagram illustrating a color measurement method in the in-line color measurement section 16 according to the present embodiment.

That is, the in-line color measurement section 16 performs color measurement of each color patch 30 by moving the color measurement head in a direction perpendicular to a sheet conveyance direction D1 while passing the chart printed sheet 32 in the sheet conveyance direction D1.

FIG. 4A illustrates the sheet conveyance direction D1 and a color measurement direction of the chart printed sheet 32 in the in-line color measurement section 16. In the in-line color measurement section 16, the chart printed sheet 32 is conveyed row by row of the color chart 31. The color measurement head moves in the opposite directions row by row to perform color measurement.

In the chart printed sheet 32 according to the present embodiment, as described with reference to FIG. 3A, the colorless cutting region 36a having a width of an integral multiple of that of the color patch(es) 30 is provided between the color patterns 34. Therefore, the in-line color measurement section 16 performs color measurement on each color patch 30 in each color pattern 34 and also performs color measurement on the cutting region 36a. The colorimetric data of the chart printed sheet 32 includes the colorimetric values.

The colorimetric data 41 of all the color patches 30 obtained by the in-line color measurement section 16 is transferred to the image processor 15.

The external color measurement section 17 is constituted of an automatic sheet-passing type colorimeter and is provided separately from the in-line color measurement section 16. The external color measurement section 17 may be provided integrally with the image forming apparatus 10, but, in the present embodiment, is provided separately. The external color measurement section 17 of the present embodiment has a narrower sheet conveyance width than that of the in-line color measurement section 16. The external color measurement section 17 has a sheet conveyance distance of 320 mm or less. The external color measurement section 17 performs color measurement on all the color patches 30 in the color patterns, and transfers colorimetric data 41 to the image processor 15.

FIG. 4B illustrates a sheet conveyance direction D2 and a color measurement direction of the pattern printed sheets 35 in the external color measurement section 17. The pattern printed sheets 35 are formed by cutting the chart printed sheet 32 in the direction perpendicular to the sheet conveyance direction D1 of the chart printed sheet 32.

The sheet conveyance direction D2 of the pattern printed sheets 35 at the time of color measurement in the external color measurement section 17 is perpendicular to the sheet conveyance direction D1 of the chart printed sheet 32 at the time of color measurement. The sheet conveyance width of the pattern printed sheets 35 is 320 mm or less. In the present embodiment, in a portion in each pattern printed sheet 35 corresponding to the margin of each pattern printed sheet 35, the sheet conveyance direction D2 of the pattern printed sheets 35 after cutting is drawn.

As shown in FIG. 4B, the external color measurement section 17 performs color measurement of each color patch 30 by moving the color measurement head in the direction perpendicular to the sheet conveyance direction D2 while passing the pattern printed sheets 35 in the sheet conveyance direction D2.

In the external color measurement section 17, the pattern printed sheets 35 are conveyed row by row of the color patterns 34, and the color measurement head moves in the opposite directions row by row, so that color measurement is performed.

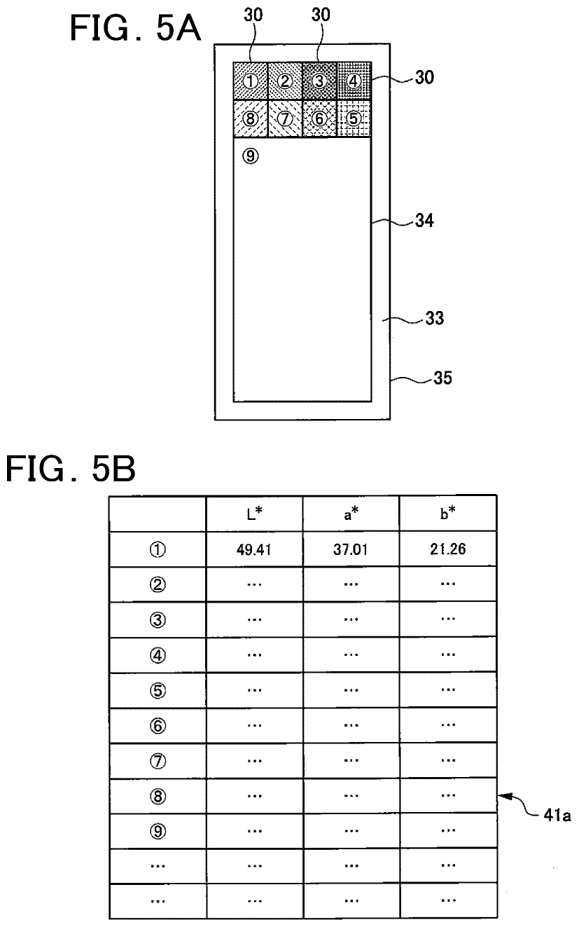

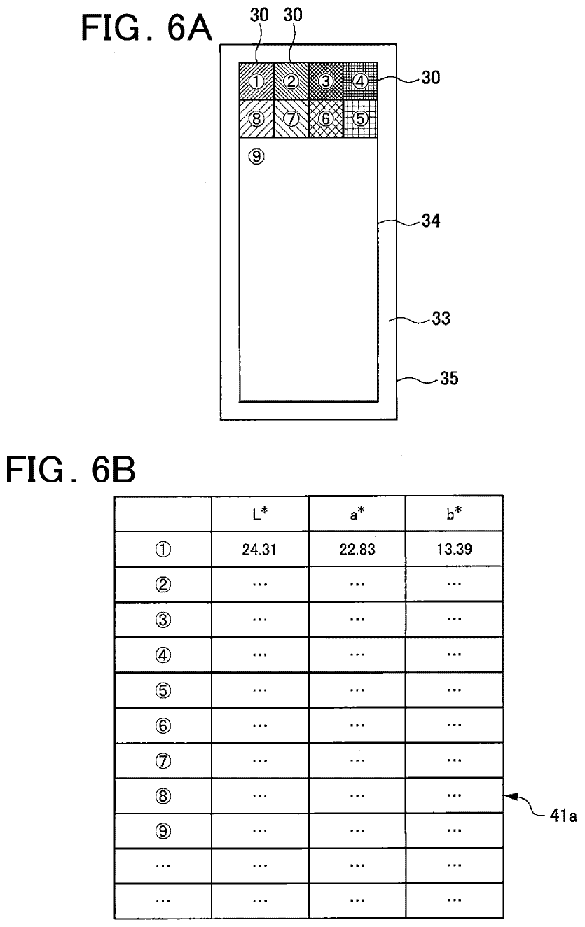

FIG. 5A and FIG. 6A illustrate examples of pattern printed sheets. FIG. 5B and FIG. 6B illustrate examples of divided colorimetric data thereof.

In the in-line color measurement section 16 and the external color measurement section 17 according to the present embodiment, the colorimetric value of each color patch 30 is obtained as numerical values in the Lab color space. The pattern printed sheets 35 illustrated in FIG. 5A and FIG. 6A are subjected to color measurement, so that the divided colorimetric data 41a illustrated in FIG. 5B and FIG. 6B are obtained. The large number of color patches 30 are sequentially subjected to color measurement along the sheet conveyance direction D2 and the movement direction of the color measurement head, so that the colorimetric values are recorded in the divided colorimetric data in order of color measurement.

Referring back to FIG. 1, the image processor 15 appropriately processes the image data generated in the DFE 11 and transfers the image data to the print engine 25 of the image forming section 12. The image processor 15 processes and utilizes the colorimetric data 41 obtained by the in-line color measurement section 16 and the divided colorimetric data 41a obtained by the external color measurement section 17.

Further, the image processor 15 compares, with a comparison section 15a (comparator), the colorimetric data 41 obtained by the in-line color measurement section 16 and/or the divided colorimetric data 41a obtained by the external color measurement section 17 with each other and also compares these with specified values or set values. Thus, the image processor 15 can evaluate each of the color measurement sections 16 and 17.

In the case where the colorimetric data 41 obtained by the in-line color measurement section 16 are used, the entire color chart 31 is printed on one chart printed sheet 32. Therefore, the image processor 15 can perform data processing while associating the setting value at each coordinate set of the color chart 31 with the colorimetric value at the coordinate set in the colorimetric data 41 of the in-line color measurement section 16. The coordinate set is a set of coordinates indicating the vertical and horizontal positions of a color patch 30.

Note that the colorimetric data 41 of the in-line color measurement section 16 include the colorimetric values of the cutting region 36a between the color patterns 34 together with the colorimetric values of the color patches 30. Therefore, the image processor 15 can obtain the colorimetric values corresponding to all the color patches 30 of the color chart 31 by discarding the colorimetric values of the cutting region 36a.

In the case where the divided colorimetric data 41a obtained by the external color measurement section 17 are used, the color chart 31 is divided into a plurality of color patterns 34 and printed on a plurality of pattern printed sheets 35. Therefore, the image processor 15 combines the divided colorimetric data 41a of the pattern printed sheets 35. Further, the image processor 15 rearranges the colorimetric values in the plurality of (multiple) divided colorimetric data 41a in order of the color patches 30 in the color chart 31. Accordingly, the image processor 15 can obtain the measured values of all the color patches 30 of the color chart 31 in the same manner as the case of the in-line color measurement section 16.

Next, operation of the image forming apparatus 10 will be described.

The image forming apparatus 10 generates image data in the DFE 11 on the basis of a print job received from an external apparatus. Then, the image forming apparatus 10 prints an image with the image forming section 12 under various settings of the operation part 13 and control of the controller 14.

During the operating period, the color chart 31 for color measurement is printed on a sheet periodically or at a timing specified through the operation part 13. Then, the in-line color measurement section 16 performs color measurement of each color patch 30 of the color chart 31. Based on the colorimetric values, the image forming section 12 performs color adjustment of the image data.

In the present embodiment, during this operating period, the image processor 15 determines necessity of maintenance, such as calibration of the in-line color measurement section 16, periodically or at a timing specified through the operation part 13. Then, when maintenance is required, the image processor 15 causes the image forming apparatus to operate, using the plurality of divided colorimetric data 41a of the external color measurement section 17. During the time, an operator removes the in-line color measurement section 16 from the image forming apparatus 10 and performs maintenance.

The determination of the necessity of maintenance is performed by comparing the colorimetric data 41 obtained by the in-line color measurement section 16 with the plurality of divided colorimetric data 41a obtained by the external color measurement section 17.

In order to obtain the colorimetric data 41 including the colorimetric values of all the color patches 30 of the color chart 31 by the in-line color measurement section 16, for example, the following is performed.

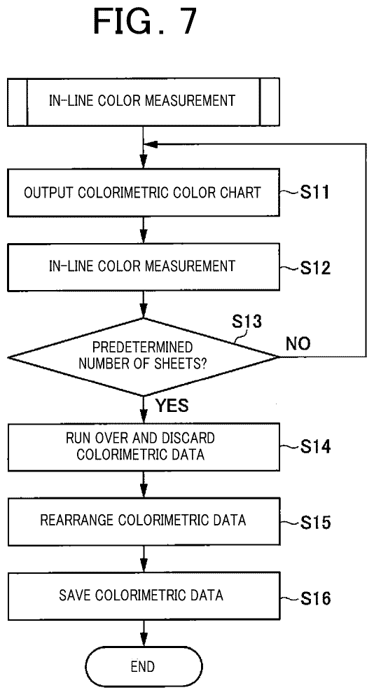

FIG. 7 is a flowchart illustrating a procedure for obtaining the colorimetric values of all the color patches 30 from the colorimetric data 41 of the in-line color measurement section.

First, the DFE 11 generates image data of the color chart 31 on the basis of a signal from the operation part 13. Then, the image forming section 12 outputs the chart printed sheet 32 with the color chart 31 printed (Step S11).

Next, based on a signal for purge processing from the controller 14, the chart printed sheet 32 is passed from the image forming section 12 as it is continuously to the in-line color measurement section 16. Then, the in-line color measurement section 16 performs color measurement of each color patch 30 of the color chart 31 of the chart printed sheet 32 (Step S12).

Next, it is determined whether the number of chart printed sheets 32 subjected to color measurement by the in-line color measurement section 16 has reached a predetermined number of sheets (Step S13).

In Step S13, if the number of chart printed sheets 32 subjected to color measurement has not reached the predetermined number of sheets (Step S13; NO), the process returns to Step S11.

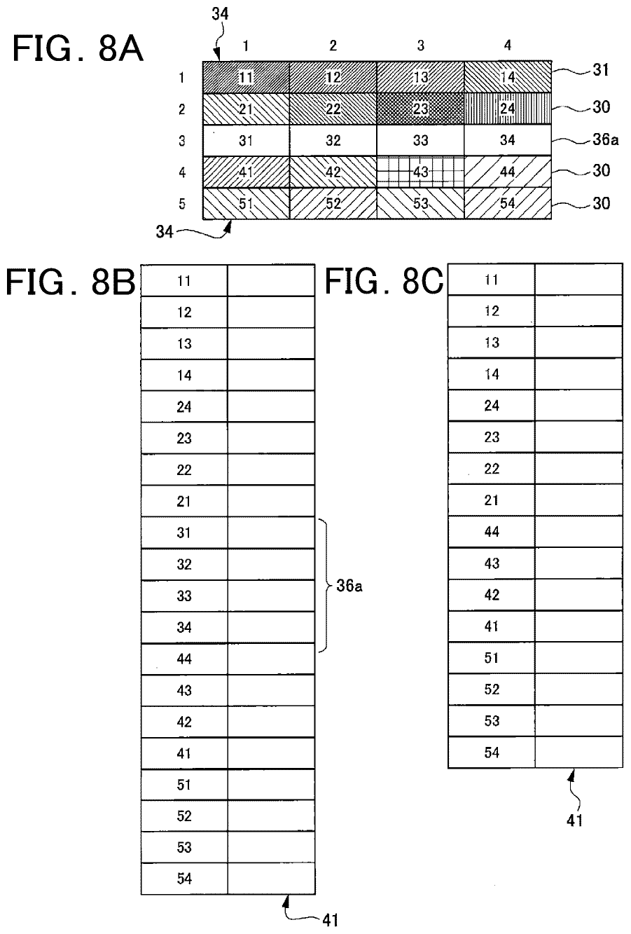

The colorimetric data 41 thus obtained is, for example, data as illustrated in FIG. 8B in the case of the color chart 31 illustrated in FIG. 8A.

Since color measurement is performed by moving the color measurement head in the opposite directions row by row, the order of rows is reversed such that the colorimetric values at the coordinates (1, 1) to (1, 4) of the color patches 30 are followed by the colorimetric values at the coordinates (2, 4) to (2, 1) of the color patches 30. In the in-line color measurement section 16, the large number of color patches 30 are subjected to color measurement in such a coordinate set order, so that the colorimetric values at the respective coordinate sets are sequentially obtained.

In Step S13, when the number of the chart printed sheets 32 subjected to color measurement has reached the predetermined number of sheets (Step S13; YES), the image processor 15 finishes color measurement of all the chart printed sheets 32. Then, the image processor 15 runs over and discards the colorimetric values at the coordinates corresponding to the cutting region 36a between the color patterns 34 (Step S14). For example, in the color chart 31 illustrated in FIG. 8A, the coordinates (3, 1) to (3, 4) are of the colorless cutting region 36a, so that the image processor 15 discards the colorimetric values at the coordinates (3, 1) to (3, 4) as illustrated in FIG. 8B.

Then, after discarding the colorimetric values of the colorless cutting region 36a, the image processor 15 rearranges the colorimetric data 41 in the state in which the coordinates and the colorimetric values correspond to each other (Step S16), and saves the colorimetric data 41 in a storage section (not illustrated) (Step S16).

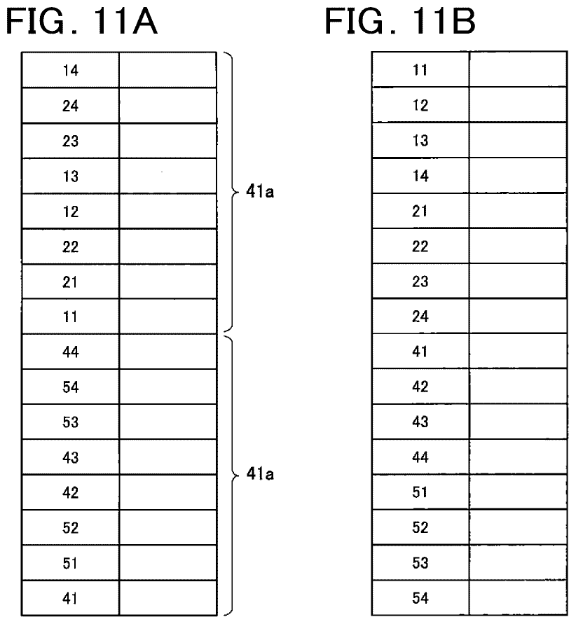

For example, with the coordinates (3, 1) to (3, 4) discarded as in FIG. 8C, the image processor 15 may arrange the colorimetric values in order of color measurement. Alternatively, the image processor 15 may arrange the colorimetric values in order of coordinates as illustrated in FIG. 11B.

The external color measurement section 17 obtains the colorimetric values of all the color patches 30 of the color chart 31 from the plurality of divided colorimetric data 41a, for example, in the following manner.

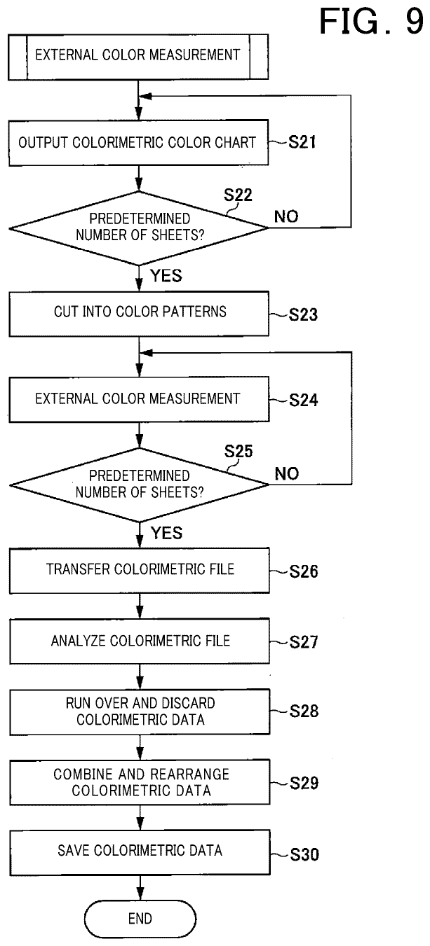

FIG. 9 is a flowchart illustrating a procedure for obtaining the colorimetric values of all the color patches 30 from the divided colorimetric data 41a of the external color measurement section.

First, based on a signal from the operation part 13, the DFE 11 generates image data of the color chart 31, and outputs the chart printed sheet 32 with the color chart 31 printed from the image forming section 12 (Step S21). The chart printed sheet 32 is ejected to the sheet ejection section 19.

Next, the image processor 15 determines whether the number of chart printed sheets 32 subjected to color measurement has reached a predetermined number of sheets (Step S22).

If it is determined in Step S22 that the predetermined number of sheets has not been reached (Step S22; NO), the process returns to Step S21, and the chart printed sheet 32 is repeatedly printed and output until the predetermined number of sheets is reached.

If the predetermined number of sheets has been reached in Step S22 (Step S22; YES), the operator cuts the printed chart printed sheet 32 along the cutting line 36b of the cutting mark 36 of the chart printed sheet 32 (Step S23).

By cutting in Step S23, the pattern printed sheets 35 with the color patterns 34 printed are produced. On the pattern printed sheets 35, the color patterns 34 into which a chart having an array common to the color chart 31 is divided are printed.

Subsequently, each of the pattern printed sheets 35 is passed through the external color measurement section 17, and the external color measurement section 17 performs color measurement of each color patch 30 of the color pattern of each pattern printed sheet 35 (Step S24). Thus, the plurality of divided colorimetric data 41a is obtained.

Subsequently, the external color measurement section 17 determines whether the number of pattern printed sheets 35 subjected to color measurement has reached a predetermined number of sheets (Step S25). If it is determined in Step S25 that the number of pattern printed sheets 35 subjected to color measurement has not reached the predetermined number of sheets (Step S25; NO), the process returns to Step S24, and the pattern printed sheet 35 is repeatedly produced and subjected to color measurement by the external color measurement section 17.

If it is determined in Step S25 that the number of pattern printed sheets 35 subjected to color measurement has reached the predetermined number of sheets (Step S25; YES), the external color measurement section 17 obtains the colorimetric values of the large number of color patches 30 in each color pattern 34 in order of color measurement.

Then, the external color measurement section 17 transfers the plurality of divided colorimetric data 41a obtained by color measurement as a colorimetric file to the image processor 15 by using a transfer section (Step S26). The transfer section may be, for example, a section that connects a storage medium in which the colorimetric file is recorded to a port for transfer of the operation part 13 or the image processor 15. Alternatively, it may be a LAN or a line for transfer that connects the external color measurement section 17 and the operation part 13 or the image processor 15 in a wireless manner or a wired manner.

The image processor 15 to which the colorimetric file has been transferred analyzes the colorimetric file (Step S27). The image processor 15 runs over and discards the colorimetric values at the coordinates corresponding to the cutting region 36a between the color patterns 34 in the color chart 31 before being cut (Step S28).

In the analysis of the colorimetric file, the image processor 15 associates the colorimetric values of the color charts 31 in the two color patterns 34 with the coordinates in the color chart 31 before being divided.

When the external color measurement section 17 performs color measurement on each pattern printed sheet 35, the sheet conveyance direction D2 is perpendicular to the sheet conveyance direction D1 of the chart printed sheet 32. Therefore, the coordinates of the colorimetric values in the divided colorimetric data 41a of each color pattern 34 are switched in terms of row and column in the coordinates of the color chart 31. Further, the order of one of the row and column is reversed.

Therefore, the order of color measurement of the colorimetric values in each color pattern 34 is complexly and regularly changed from the arrangement of the color chart 31 before being divided.

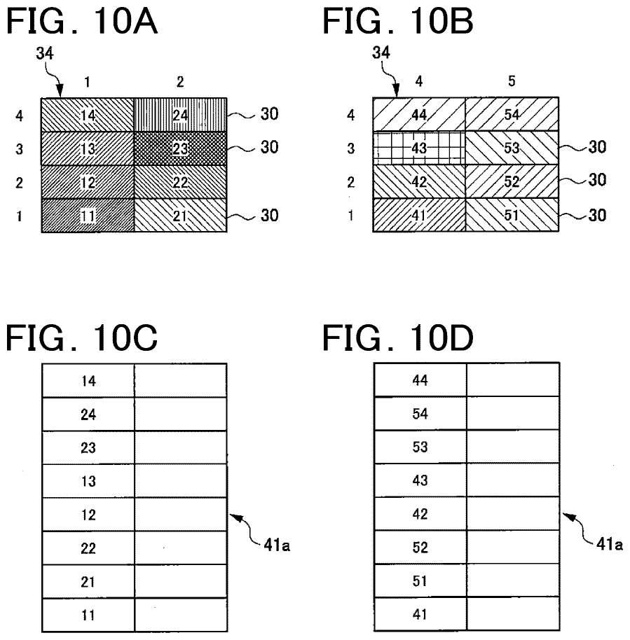

For example, the color patterns 34 illustrated in FIG. 10A and FIG. 10B are obtained by dividing the color chart 31 illustrated in FIG. 8A. Their divided colorimetric data 41a are as illustrated in FIG. 10C and FIG. 10D.

The first, second, fourth and fifth rows in the color chart 31 in FIG. 8A correspond to the first and second columns in FIG. 10A and the fourth and fifth columns in FIG. 10B, respectively. Further, the first, second, third and fourth columns in the color chart 31 in FIG. 8A correspond to the fourth, third, second and first rows in FIG. 10A and FIG. 10B, respectively.

In addition, the external color measurement section 17 performs color measurement on the color patterns 34 in FIG. 10A and FIG. 10B by moving the color measurement head in the opposite directions row by row. Therefore, the order is reversed such that the colorimetric values at the coordinates (1, 4) and (2, 4) are followed by the colorimetric values at the coordinates (2, 3) and (1, 3). Similarly, the order is reversed such that the colorimetric values at the coordinates (4, 4) and (5, 4) are followed by the colorimetric values at the coordinates (5, 3) and (4, 3).

Thus, the colorimetric values recorded in order of color measurement in the respective divided colorimetric data 41a are, if represented by the coordinates in the original color chart 31, as illustrated in FIG. 10C and FIG. 10D, respectively.

Then, the image processor 15 associates the colorimetric values in order of color measurement of the respective divided colorimetric data 41a with the coordinates in the color chart 31 before being divided, and combines and rearranges the plurality of divided colorimetric data 41a (Step S29).

In combining and rearranging the divided colorimetric data 41a, the image processor 15 can arrange the colorimetric values in various orders. For example, as illustrated in FIG. 8C, the image processor 15 may arrange the colorimetric values in the same order as the order of color measurement of the color chart 31 before being divided. Alternatively, the image processor 15 may simply connect the two divided colorimetric data 41a as illustrated in FIG. 11A. Still alternatively, the image processor 15 may arrange the colorimetric values in order of coordinates in the color chart 31 as illustrated in FIG. 11B.

Note that by using the colorimetric values of some of the color patches 30 included in the divided colorimetric data 41a of the color patterns 34, the image processor 15 can estimate the positions in the color chart 31 and perform combining.

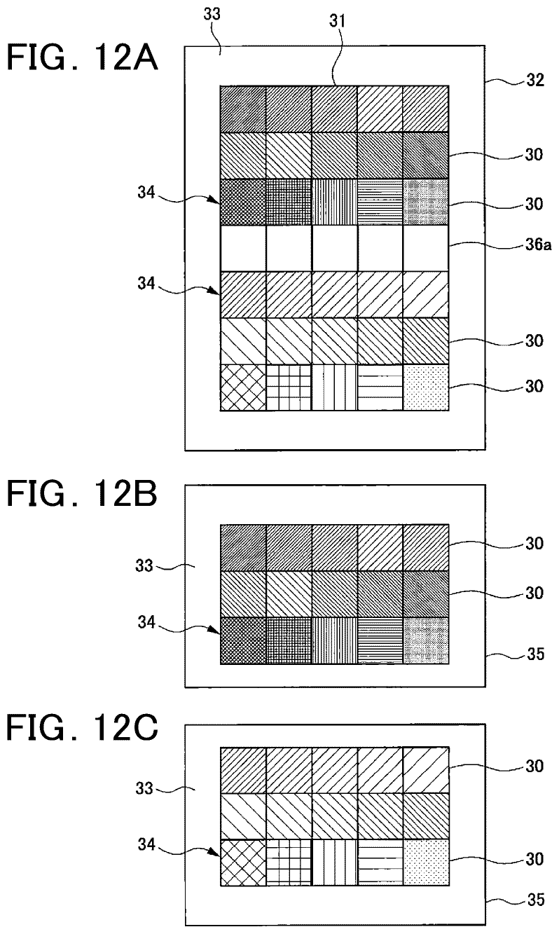

For example, the color chart 31 illustrated in FIG. 12A is divided into the two color patterns 34 illustrated in FIG. 12B and FIG. 12C. The color chart 31 is constituted of color patches 30 all different in color.

Therefore, from the colorimetric values of some of the color patterns 34 illustrated in FIG. 12B and FIG. 12C, the external color measurement section 17 can estimate the positions in the color chart 31 illustrated in FIG. 12A.

Then, the external color measurement section 17 combines the divided colorimetric data 41a with each other such that the color patterns 34 are at the estimated positions. Thus, the external color measurement section 17 can combine the colorimetric data 41 corresponding to all the color patches of the color chart 31.

Thereafter, the combined and rearranged colorimetric data 41 is saved (Step S30). Thus, the image processor 15 can obtain the colorimetric values of all the color patches 30 of the color chart 31.

Next, the in-line color measurement section 16 compares the obtained colorimetric data 41 with the colorimetric data 41 obtained and combined by the external color measurement section 17 to determine whether maintenance is required. The determination by the in-line color measurement section 16 is performed by comparing the colorimetric values at the same coordinates in the color chart 31, for all of the color patches 30. That is, the in-line color measurement section 16 determines whether a difference between the obtained colorimetric data 41 and the colorimetric data 41 obtained and combined by the external color measurement section 17 is within a preset reference range. In other words, the in-line color measurement section 16 determines that maintenance is necessary if the difference is out of the preset reference range.

In the case where it is determined that maintenance is required, for example, in a case where the in-line color measurement section 16 breaks down or in a case where calibration of the in-line colorimeter needs to be performed, the in-line color measurement section 16 is removed and maintenance is performed.

During maintenance, as during the normal operating period, periodically or at a timing specified through the operation part 13, the color chart 31 for color measurement is printed on a sheet, the color of each color patch 30 is measured, and color adjustment is performed.

At the time, since the in-line color measurement section 16 is removed, the external color measurement section 17 cuts the chart printed sheet 32 to produce the pattern printed sheets 35 and performs color measurement. Thus, in the same manner described above, the divided colorimetric data 41a of the color patterns 34 into which a chart having an array common to the color chart 31 is divided are obtained. The external color measurement section 17 combines the plurality of divided colorimetric data 41a to obtain the colorimetric values of all the color patches 30 in the color chart 31.

Thus, based on the colorimetric values combined and obtained from the color patterns 34, the external color measurement section 17 can perform color adjustment, so that maintenance of the in-line color measurement section 16 can be performed while the image forming apparatus 10 is in operation.

Next, effects obtained by the image forming apparatus 10, the maintenance method of the color measurement section or the chart printed sheet 32 for color measurement according to the present embodiment will be described.

First, in the present embodiment, the image processor 15 can obtain the colorimetric values of all the color patches 30 of the color chart 31 from the colorimetric data 41 of the in-line color measurement section 16. Further, the image processor 15 can obtain the colorimetric values of all the color patches 30 by combining the divided colorimetric data 41a of the color patterns 34 into which a chart having an array common to the color chart 31 is divided.

Therefore, the image processor 15 can compare the colorimetric values obtained from the color chart 31 with the colorimetric values obtained from the color patterns 34. Further, the image processor 15 can use the colorimetric values combined and obtained from the color patterns 34 instead of the colorimetric values obtained from the color chart 31.

In addition, in any case, the image processor 15 can collectively obtain the colorimetric values from the colorimetric data 41 of the color chart 31 or from the divided colorimetric data 41a of the color patterns 34. Therefore, the operator does not have to take the trouble of obtaining a large number of colorimetric values individually. Further, even if the number of color patches 30 is large, the image processor 15 can easily evaluate and/or replace the in-line color measurement section 16.

As a result, even if the in-line color measurement section 16 is capable of performing color measurement on a large color chart 31, the operator can easily perform maintenance of the in-line color measurement section 16.

In the present embodiment, the chart printed sheet 32 on which the color chart 31 is printed is a large size. That is, the chart printed sheet 32 has a width of more than 320 mm that cannot be passed through a general automatic sheet-passing type colorimeter. However, in the present embodiment, the chart printed sheet 32 is cut, so that the pattern printed sheets 32 on which the color patterns 34 are printed each have a width equal to or less than 320 mm. Therefore, the external color measurement section 17 can easily perform color measurement of all the color patches 30 of the color chart 31 with a general automatic sheet-passing type colorimeter, the color chart 31 being divided and passed through.

In the present embodiment, the pattern printed sheets 35 on which the color patterns 34 are printed are formed by cutting the chart printed sheet 32 on which the color chart 31 is printed. Therefore, in the present embodiment, it is possible to reliably and easily obtain the color patterns 34 into which an array common to the color chart 31 is divided.

In the present embodiment, the chart printed sheet 32 is provided with the cutting mark 36 indicating the position for cutting between the color patterns 34. Therefore, the operator can easily produce the pattern printed sheets having appropriate color patterns 34.

In the present embodiment, the cutting mark 36 includes the colorless cutting region 36a that is provided between the color patterns 34 and has a width of an integer multiple of the width of the color patch(es) 30. Therefore, the color patches 30 of the color chart 31 are subjected to color measurement, it is not necessary to perform control to change the movement amount of the color measurement head between the color patterns 34. Therefore, it is possible to simplify the control at the time of color measurement in the in-line color measurement section 16.

In the present embodiment, the image processor 15 performs color measurement of the cutting region 36a in the color chart 31 as well as the color patches 30 of the color patterns 34, and discards the colorimetric values of the cutting region 36a. Therefore, the image processor 15 can perform control so as to continuously measure the colors of the color patches 30 of the color patterns 34 regardless of whether it is the cutting region 36a. Therefore, the image processor 15 can simplify the control at the time of color measurement.

In the present embodiment, the pattern printed sheets 35 are formed by cutting the chart printed sheet 32 in the direction perpendicular to the sheet conveyance direction D1 at the time of color measurement of the chart printed sheet 32. These pattern printed sheets 35 are produced by cutting the chart printed sheet 32 such that the length of each of the pattern printed sheets 35 along the sheet conveyance direction D1 at the time of color measurement of the chart printed sheet 32 is shorter than the length thereof in the perpendicular direction.

The sheet conveyance direction D2 at the time of color measurement of the pattern printed sheets 35 is perpendicular to the sheet conveyance direction D1 at the time of color measurement of the chart printed sheet 32.

Therefore, even in the case of the color chart 31 of the chart printed sheet 32 having a large width, by dividing the color chart 31 into the pattern printed sheets 35, color measurement can be performed with the width at the time of color measurement narrower.

Thus, even in the case of the color chart of the chart printed sheet 32 having a large width, a colorimeter that cannot perform color measurement with the width of the chart printed sheet 32 can perform color measurement. For example, a general colorimeter can be used to measure the colors of the color chart 31.

In the present embodiment, the sheet conveyance direction D2 of the pattern printed sheets 35 after cutting is drawn on the chart printed sheet 32. Therefore, the operator does not make a mistake about the sheet conveyance direction D2 of the pattern printed sheets 35, and can prevent an error in sheet passing.

In the present embodiment, the image processor 15 can rearrange and combine the colorimetric values in the divided colorimetric data 41a of the color patterns 34. Therefore, in rearranging the colorimetric values, the image processor 15 can rearrange the colorimetric values in order of the color patches 30 in the color chart 31.

This makes it easy to grasp the colorimetric values of the respective color patches 30 in the color chart 31, and therefore the control for color adjustment and tone adjustment can be simplified.

In the present embodiment, the shapes of the color patches 30 are the same between the color patterns 34. Therefore, it is not necessary for the in-line color measurement section 16 to change the settings color pattern 34 by color pattern 34 at the time of color measurement with the color measurement head, and the accuracy of color measurement can be homogenized. Thus, the control and operation of the colorimeter can be simplified, and the ease of use of the image forming apparatus is improved.

In the present embodiment, the number of color patches 30 arranged vertically and the number thereof arranged horizontally are the same between the color patterns 34. Therefore, it is not necessary for the external color measurement section 17 to change the settings color pattern 34 by color pattern 34 at the time of color measurement with the color measurement head, and the accuracy of color measurement can be homogenized. Thus, the control and operation of the colorimeter can be simplified, and the ease of use of the image forming apparatus is improved.

In the present embodiment, the image processor 15 estimates the arrangement(s) of the color pattern(s) 34 in the color chart 31 based on the colorimetric values of some of the color patches 30 (i.e., one or more of the colorimetric values of the color patches 30) in the color pattern(s) 34. Further, the image processor 15 combines the divided colorimetric data 41a of the color pattern 34 and the divided colorimetric data 41a of the other color pattern 34 on the basis of the estimated arrangement. The estimation based on the colorimetric values of the color patches 30 reduces influence of noise or the like.

Therefore, the image processor 15 can easily perform combining the divided colorimetric data 41a obtained from the color patterns 34 with each other, thus simplifying the structure for data processing.

Further, since the image processor 15 does not need special processing, such as determining the order of color measurement or specifying the position(s) when performing color measurement on each color pattern 34 or combining the divided colorimetric data 41a with each other, it is possible to improve the usability of the image forming apparatus.

In the present embodiment, the colorimetric values of the color patches 30 obtained from the colorimetric data 41 of the color chart 31 are compared with the colorimetric values of the color patches 30 obtained by combining the divided colorimetric data 41a of the color patterns 34. Then, the image processor 15 determines, from the comparison result, whether maintenance, such as calibration of the color measurement head of the in-line colorimeter, is required.

Therefore, in addition to reducing the time and effort for the control and operation for determining the necessity of calibration, the image processor 15 can easily compare the difference in each color patch 30, and can detect the difference even if the difference occurs in some of the colors. As a result, the image forming apparatus 10 can appropriately maintain the in-line colorimeter for a long period of time.

In the present embodiment, color measurement of the color patterns 34 is performed using the external color measurement section 17, which is separately provided from the in-line color measurement section 16. Since the color patterns 34 are obtained by dividing the color chart 31, the width of the pattern printed sheets 35 is narrower than that of the chart printed sheet 32. Therefore, as the external colorimeter, a colorimeter whose maximum width of the sheet conveyance width is narrower than that of the in-line color measurement section 16 can be used. Thus, the usability of the image forming apparatus is improved.

Note that the above-described embodiment can be appropriately modified within the scope of claims.

For example, in the above-described embodiment, the color patterns 34 in the pattern printed sheets 35 are subjected to color measurement by the external color measurement section 17, but this is not a limitation. For example, the pattern printed sheets 35 may be separately supplied to the in-line color measurement section 16 discontinuously from the image forming section 12 to be subjected to color measurement. By combining the divided colorimetric data 41a of the color patterns 34 thus obtained, the image processor 15 may obtain the colorimetric values of all the color patches 30 of the color chart 31.

Further, in the above-described embodiment, the image processor 15 obtains the colorimetric values of all the color patches 30 of the color chart 31, but this is not a limitation. The present disclosure can be applied to a case where the image processor 15 obtains the colorimetric values of some of the color patches 30 of the color chart 31 and performs color adjustment.

Further, in the above-described embodiment, the color patterns 34 of the pattern printed sheets 35 are subjected to color measurement by the external color measurement section 17, but the pattern printed sheets 35 may be subjected to color measurement by the in-line color measurement section 16.

Further, in the above-described embodiment, as the color patterns 34 into which a chart having an array common to the color chart 31 is divided, those into which the color chart 31 itself, which is subjected to color measurement by the in-line color measurement section 16, is divided are exemplified, but this is not a limitation.

The chart having an array common to the color chart 31 may be, for example, a chart formed separately from the color chart 31 that is subjected to color measurement by the in-line color measurement section 16. Further, the chart having an array common to the color chart 31 may be a chart in which the color patterns 34 are separately printed.

Further, in the above-described embodiment, since it is sufficient that the large number of color patches 30 are arranged in the same order as the color chart 31, even a chart in which color patches 30 are different in shape and/or size can be used for the color patterns 34.

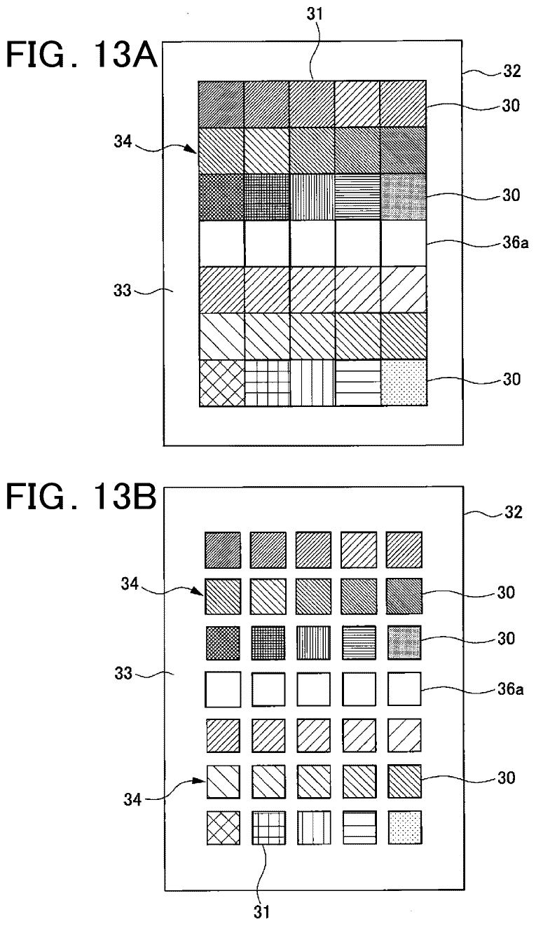

For example, as the color chart 31 on which color measurement is performed by the in-line color measurement section 16, a chart in which rectangular (or square) color patches 30 are arranged adjacent to each other as illustrated in FIG. 13A can be used. At the same time, as the color chart 31 for creating the color patterns 34 on which color measurement is performed by the external color measurement section 17, as illustrated in FIG. 13B, a chart in which color patches 30 smaller in size than those in FIG. 13A can be used.

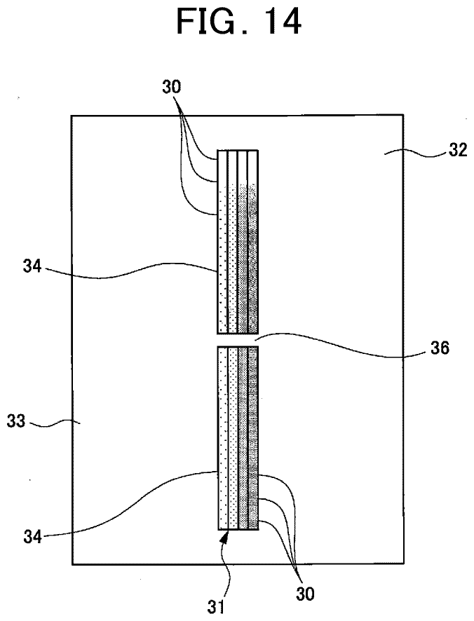

Further, the color chart 31 or the color patterns 34 may be printed on only a part of a sheet, like, as illustrated in FIG. 14, the chart printed sheet 32 or the pattern printed sheets 35. In that case, the color chart 31 or the color patterns 34 is/are always printed at the same position(s), so that it is possible to prevent influence of unevenness due to the arrangement.

In the above-described embodiment, when it is determined that maintenance is required, color adjustment is performed using the colorimetric values of the color patches 30 obtained by combining the multiple divided colorimetric data 41a, but this is not a limitation. It is possible to perform color adjustment using the colorimetric data obtained by combining the multiple divided colorimetric data 41a by the external color measurement section 17 without obtaining the colorimetric data by the in-line color measurement section 16.

In the above, paper is used as the sheet(s) on which the color chart 31 or the color patterns 34 is/are printed, but other recording media, such as films, may be used.

Although embodiments of the present invention have been described and shown in detail, the disclosed embodiments are made for purposes of illustration and example only and not limitation. The scope of the present invention should be interpreted by terms of the appended claims.

What is claimed is:

1. An image forming apparatus comprising:
an image former that prints a color chart on a sheet;
an in-line colorimeter that performs color measurement of color patches formed on the color chart; and
an image processor that performs color adjustment based on colorimetric values of the color patches formed on the color chart,
wherein the image processor combines multiple divided colorimetric data obtained by performing color measurement of color patterns into which a chart is divided, the chart in which color patches are arrayed to be common to the color chart, and obtains colorimetric values of the color patches formed on the color chart from the multiple divided colorimetric data combined.

2. The image forming apparatus according to claim 1,
wherein a width of a chart printed sheet with the color chart printed exceeds 320 mm, and
wherein each of widths of pattern printed sheets with the color patterns printed is equal to or less than 320 mm.

3. The image forming apparatus according to claim 1, wherein pattern printed sheets with the color patterns printed are formed by cutting a chart printed sheet with the color chart printed.

4. The image forming apparatus according to claim 3, wherein the chart printed sheet is provided with a cutting mark indicating a position for cutting between the color patterns.

5. The image forming apparatus according to claim 4, wherein the cutting mark has a colorless cutting region that is provided between the color patterns and has a width of an integral multiple of a width of each of the color patches.

6. The image forming apparatus according to claim 5, wherein the in-line colorimeter performs color measurement of the cutting region in the color chart as well the color patches of the color patterns, and discards a colorimetric value of the cutting region.

7. The image forming apparatus according to claim 3,
wherein the pattern printed sheets are formed by cutting the chart printed sheet in a direction perpendicular to a sheet conveyance direction at a time of color measurement of the chart printed sheet such that a length of each of the pattern printed sheets along the sheet conveyance direction is shorter than a length of each of the pattern printed sheets along the direction perpendicular to the sheet conveyance direction, and
wherein a sheet conveyance direction at a time of color measurement of the pattern printed sheets is perpendicular to the sheet conveyance direction at the time of color measurement of the chart printed sheet.

8. The image forming apparatus according to claim 3, wherein on the chart printed sheet, a sheet conveyance direction of the pattern printed sheets after the cutting is drawn.

9. The image forming apparatus according to claim 1, wherein the image processor is capable of rearranging and combining the colorimetric values in the divided colorimetric data of the color patterns in order of the color patches in the color chart.

10. The image forming apparatus according to claim 1, wherein shapes of the color patches are same between the color patterns.

11. The image forming apparatus according to claim 1, wherein a number of the color patches arrayed vertically and a number of the color patches arrayed horizontally are same between the color patterns.

12. The image forming apparatus according to claim 1, wherein the image processor is capable of estimating arrangement of the color patterns in the color chart based on one or more of the colorimetric values of the color patches in the color patterns and combining the divided colorimetric data of the color patterns based on the estimated arrangement.

13. The image forming apparatus according to claim 1, wherein the image processor includes a comparator that compares colorimetric data obtained by the in-line colorimeter performing color measurement of the color patches formed on the color chart with the multiple divided colorimetric data combined.

14. The image forming apparatus according to claim 13, wherein the image processor is capable of determining from a comparison result of the comparator whether maintenance of the in-line colorimeter is needed.

15. The image forming apparatus according to claim 1, further comprising an external colorimeter that is separately provided from the in-line colorimeter, and performs color measurement of the color patterns.

16. A maintenance method of a colorimeter of an image forming apparatus that prints a color chart on a sheet, performs color measurement of color patches formed on the color chart with an in-line colorimeter, and performs color adjustment based on colorimetric values of the color patches formed on the color chart, the maintenance method comprising:
combining multiple divided colorimetric data obtained by performing color measurement of color patterns into which a chart having an array common to the color chart is divided, and obtaining colorimetric values of the color patches; and
comparing the colorimetric values obtained from the color chart with the colorimetric values obtained from the color patterns, thereby determining whether maintenance of the in-line colorimeter is needed.

17. A maintenance method of a colorimeter of an image forming apparatus that prints a color chart on a sheet, performs color measurement of color patches formed on the color chart with an in-line colorimeter, and performs color adjustment based on colorimetric values of the color patches formed on the color chart, the maintenance method comprising:
combining multiple divided colorimetric data obtained by performing color measurement of color patterns into which a chart having an array common to the color chart is divided, and obtaining colorimetric values of the color patches, and
based on the colorimetric values, carrying out maintenance of the in-line colorimeter as well as performing color adjustment.
